(19) United States
(12) Patent Application Publication
(10) Pub. No.: US 2023/0162396 A1
(43) Pub. Date: May 25, 2023

(54) INDOOR LOCATION SYSTEM FOR EMERGENCY RESPONDERS AND/OR CONTACT TRACKING AND TRACING

(71) Applicant: CommScope Technologies LLC, Hickory, NC (US)

(72) Inventors: Michael Gregory German, Secaucus, NJ (US); Arndt Paul Pischke, Huisheim (DE); LeaAnn Harrison Carl, Plano, TX (US); Ernest C. Pickens, Fairview, TX (US)

(73) Assignee: CommScope Technologies LLC, Hickory, NC (US)

(21) Appl. No.: 17/996,896

(22) PCT Filed: Apr. 15, 2021
(86) PCT No.: PCT/US2021/027423

§ 371 Date: Oct. 21, 2022

Related U.S. Application Data
(60) Provisional application No. 63/049,732, filed on Jul. 9, 2020.
(60) Provisional application No. 63/014,424, filed on Apr. 23, 2020.

(51) Int. Cl. G06T 7/73; G06T 19/00; G06V 10/44; G06V 20/50; G06T 7/246

(52) U.S. Cl. CPC G06T 7/75; G06T 19/006; G06V 10/44; G06V 20/50; G06T 7/251; G06T 2207/30244; G06T 2200/04

(57) ABSTRACT

One embodiment is directed to determining a location of a mobile device associated with an occupant within an indoor area using one or more images captured by at least one camera of the mobile device and a digital three-dimensional model of the indoor area. Information about the location of the mobile device is communicated to an emergency responder. Another embodiment is directed to determining the locations of each mobile device associated with each occupant within an indoor area using one or more images captured using at least one camera of the mobile device, storing each determined location along with an associated time stamp, and using at least some of the stored locations and time stamps in performing contact tracing. Other embodiments are disclosed.

### CROSS-REFERENCE TO RELATED APPLICATIONS

This application claims the benefit of U.S. Provisional Patent Application Ser. No. 63/014,424, filed on Apr. 23, 2020, and U.S. Provisional Patent Application Ser. No. 63/049,732, filed on Jul. 9, 2020, both of which are hereby incorporated herein by reference in their entirety.

### BACKGROUND

It is desirable to be able to determine the location of mobile devices and their users within large buildings (such as office buildings, apartment buildings, hotels, shopping centers, and airports). For example, the location of a mobile device within a building can be used by an emergency responder (such as a police officer, fire fighter, or paramedic) to locate the user of that mobile device in an emergency situation.

However, some approaches to identifying the location of mobile devices are not suitable for use in large buildings. For example, satellite-based radio-navigation systems (such as the Global Positioning Systems (GPS)) often do not work inside large buildings due to the difficulty in receiving satellite signals inside of such buildings. Moreover, the variations in signal attenuation caused by different building materials and designs, as well as the use of repeater systems within large buildings, often render traditional cellular triangulation techniques inadequate for locating a mobile device with sufficient resolution for an emergency responder to easily locate the associated user.

### SUMMARY

One embodiment is directed to a method of determining a location of a mobile device associated with an occupant within an indoor area. The method comprises receiving one or more images captured using at least one camera of the mobile device, determining the location of the mobile device within the indoor area using the one or more images and a digital three-dimensional model of the indoor area, and communicating information about the location of the mobile device to an emergency responder.

Another embodiment is directed to a system for determining a location of a mobile device associated with an occupant within an indoor area. The system comprises an occupant mobile device used by the occupant, the occupant mobile device configured to execute occupant mobile software and comprising at least one camera. The system further comprises a responder mobile device used by an emergency responder, the responder mobile device configured to execute responder mobile software. The occupant mobile software is configured to capture one or more images using at least one camera of the occupant mobile device. The system is configured to determine the location of the responder mobile device within the indoor area using one or more images and a digital three-dimensional model of the indoor area. The system is configured to communicate information about the location of the mobile device to the responder mobile device.

Another embodiment is directed to a method of tracking locations of mobile devices associated with occupants within an indoor area. The method comprises receiving one or more images captured using at least one camera of the respective mobile device associated with each occupant within the indoor area, determining the location of each mobile device within the indoor area using the respective one or more images and a digital three-dimensional model of the indoor area, storing each determined location of each occupant mobile device of each occupant of the indoor area along with an associated time stamp, and using at least some of the stored locations and time stamps in performing contact tracing.

Another embodiment is directed to a system for determining a location of mobile devices associated with occupants within an indoor area. The system comprises occupant mobile devices used by the occupants. The occupant mobile devices are configured to execute occupant mobile software and each comprise at least one camera. The occupant mobile software executed by each occupant mobile device is configured to capture one or more images using at least one camera of that occupant mobile device. The system is configured to determine the location of each mobile device within the indoor area using the respective one or more images and a digital three-dimensional model of the indoor area, store each determined location of each occupant mobile device of each occupant of the indoor area along with an associated time stamp, and use at least some of the stored locations and time stamps in performing contact tracing.

Other embodiments are disclosed.

The details of various embodiments are set forth in the accompanying drawings and the description below. Other features and advantages will become apparent from the description, the drawings, and the claims.

### DRAWINGS

FIGS. 1-2 illustrates one exemplary embodiment of an indoor location system for determining the location of mobile devices and their users within an indoor area.

FIG. 3 comprises a high-level flowchart illustrating one exemplary embodiment of a method of determining a location of a mobile device associated with an occupant within an indoor area.

FIG. 4 illustrates one example of how the locations of current occupants of an indoor area can be displayed for an emergency responder.

FIG. 5 illustrates one example of how a panoramic image of part of an indoor area can be displayed for an emergency responder.

FIG. 6 comprises a high-level flowchart illustrating one example of a method of determining route information to the location of an occupant mobile device for an emergency responder.

FIG. 7 illustrates one example of how route information can be displayed for an emergency responder.

FIG. 8 illustrates one example of how an augmented reality (AR) view of an indoor area that superimposes route information on a live image of the area currently being captured by one or more cameras of a responder mobile device.

FIG. 9 comprises a high-level flowchart illustrating one exemplary embodiment of a method of tracking the locations of mobile devices associated with occupants within an indoor area.

FIG. 10 comprises a high-level flowchart illustrating one exemplary embodiment of a method of tracing contacts of a person who was an occupant of an indoor area.

Like reference numbers and designations in the various drawings indicate like elements.

### DETAILED DESCRIPTION

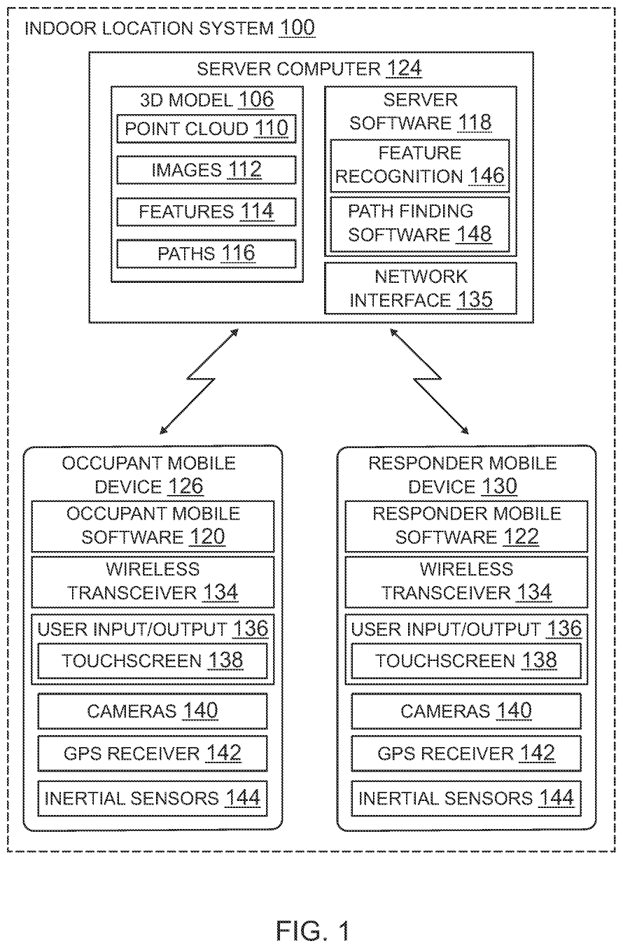

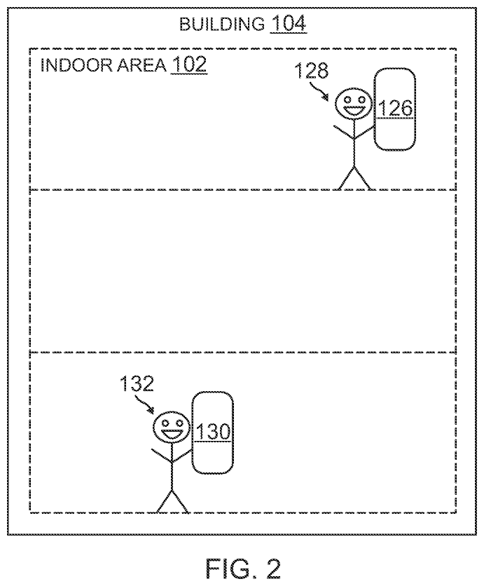

FIGS. 1-2 illustrates one exemplary embodiment of an indoor location system 100 (shown in FIG. 1) for determining the location of mobile devices and their users within an indoor area 102 (shown in FIG. 2). In the exemplary embodiment described here in connection with FIGS. 1-2, the indoor area 102 comprises the interior of a building 104 (such as an office building, apartment building, hotel, shopping center, or airport).

The system 100 makes use of a digital three-dimensional (3D) model 106 (shown in FIG. 1) of the indoor area 102. The digital 3D model 106 comprises a digital representation of the physical and functional characteristics of the indoor area 102 and the building 104. In this exemplary embodiment, the digital 3D model 106 of the indoor area 102 (and building 104) is generated for use in a building information model (BIM) maintained by a BIM system. The indoor location system 100 can be configured to include (or have a real-time interface to) the BIM system used for the building 104. With such an approach, the indoor location system 100 can access the most up-to-date digital 3D model 106 for the building 104 used by the BIM system.

Alternatively, the indoor location system 100 can be implemented separately from (and without a real-time interface to) the BIM system. With this approach, the digital 3D model 106 can be exported from the BIM system and imported into the indoor location system 100 (with updates to the digital 3D model 106 supplied from the BIM system to the indoor location system 100 periodically).

In this exemplary embodiment, the digital 3D model 106 comprises a plurality of points 110 captured by scanning the indoor area 102. The plurality of points 110 is also referred to as a “point cloud.” The location of each point in the point cloud 110 is precisely determined (for example, using laser scanners and Light Detection and Ranging (LIDAR) techniques). The point cloud 110 is used to georeference images 112 of the indoor area 102. The images 112 can be captured as a part of the scanning process. The scanning of the indoor area 102 (by which the point cloud 110 and the images 112 are captured) can be performed from a plurality of locations within the indoor area 102.

The resulting point cloud 110 is processed by photogrammetric software in order to generate the digital 3D model 106 of the indoor area 102. The digital 3D model 106 includes, or can be used to generate, visualizations of the indoor area 102, including both image-based visualizations based on the captured images 112 and computer-generated visualizations.

Conventional scanners and photogram metric software can be used to generate the digital 3D model 106 of the indoor area 102.

The digital 3D model 106 for the indoor area 102 also includes building feature information 114 that identifies structures (such as walls, ceilings, and floors) and passageways (such as doors, windows, stairways, and elevators). The digital 3D model 106 for the indoor area 104 also includes path information 116 that identifies paths between various locations within the indoor area 102. These features and paths can be defined manually (for example, by having a user use the BIM system or photogrammetric software to tag or otherwise mark such features and paths in a visualization of the indoor area 102), can be defined using “as designed” information (for example, by importing blueprints or computer aided design (CAD) models), defined using “as built” information (for example, by using feature-recognition software to automatically recognize such features and paths in the point cloud 110 or images 112), or combinations thereof.

In this exemplary embodiment, the digital 3D model 106 that was generated for use in the BIM system to plan, design, construct, and/or manage the building 104 is also used in the indoor location system 100, thereby avoiding having to invest the time and resources to generate the digital 3D model 106 solely for the purpose of the indoor location system 100. It is to be understood that the digital 3D model 106 can be generated in other ways and for other purposes. In one example, the digital 3D model 106 can be generated in connection with the construction of the building 104. For example, an “as designed” digital 3D model can be generated (for example, from CAD models) and an “as built” digital 3D model can be generated (for example, by scanning the building 104), where the “as designed” and “as built” digital 3D models are compared in order to identify any deviations between the building 104 as it was designed and as it was actually built. The “as designed” and/or “as built” digital 3D models generated in connection with this process can also be used for the purpose of the indoor location system 100. In another example, the digital 3D model 106 can be generated in connection with providing insurance for the building 104. For example, a digital 3D model can be generated in order to document the state of the building 104 prior to any claims being made under the insurance policy. The digital 3D model generated in connection with this insurance process can also be used for the purpose of the indoor location system 100. In another example, the digital 3D model 106 can be generated in connection with investigating or litigating an incident occurring in the building 104. For example, a digital 3D model can be generated in order to analyze, reconstruct, and/or determine a cause of, or liability for, an incident occurring in the building 104 (such as an accident or crime). The digital 3D model generated in connection with the investigation or litigation process can also be used for the purpose of the indoor location system 100. The digital 3D model 106 can be generated for other purposes.

Also, the digital 3D model 106 can be generated solely for the purpose of the indoor location system 100.

Moreover, although the digital 3D model 106 is described above as being generated using laser scanners and LIDAR techniques, it is to be understood that the digital 3D model 106 can be generated in other ways (for example, using depth scanners or image-based photogrammetry).

In the exemplary embodiment shown in FIG. 1, the indoor location system 100 comprises server software 118, occupant mobile software 120, and responder mobile software 122. The server software 118 is configured to execute on one or more server computers 124 (for example, the same set of server computers on which at least a part of the software that implements the BIM system executes). The occupant mobile software 120 is configured to execute on, or otherwise interact with, mobile devices 126 used by occupants 128 of the indoor area 102 (one of which is shown in FIG. 2). These mobile devices 126 are also referred to here as “occupant” mobile devices 126. The responder mobile software 122 is configured to execute on, or otherwise interact with, mobile devices 130 used by emergency responders 132 (one of which is shown in FIG. 2). These mobile devices 130 are also referred to here as “responder” mobile devices 130.

Examples of occupant and responder mobile devices 126 and 130 include, for example, smartphones, smart watches, smart glasses, tablets, laptop computers, and other wearable computers. Also, the occupant mobile devices 126 need not be the same as the responder mobile devices 128. Also, all of the occupant mobile devices 126 need not be implemented in the same way. Likewise, all of the responder mobile devices 130 need not be implemented in the same way.

In the exemplary embodiment shown in FIG. 1, each device on which the software 118, 120, and 122 executes comprises one or more programmable processors for executing the software 118, 120, and 122. The software 118, 120, and 122 comprises program instructions that are stored (or otherwise embodied) on or in an appropriate non-transitory storage medium or media (such as flash or other non-volatile memory, magnetic disc drives, and/or optical disc drives) from which at least a portion of the program instructions are read by the respective programmable processor for execution thereby. Both local storage media and remote storage media (for example, storage media that is accessible over a network), as well as removable media, can be used. Each device also includes memory for storing the program instructions (and any related data) during execution by the respective programmable processor. The memory comprises, in one implementation, any suitable form of random access memory (RAM) now known or later developed, such as dynamic random access memory (DRAM). In other embodiments, other types of memory are used.

Each device also includes one or more network interfaces for communicatively coupling the respective device to one or more networks (for example, a wired local area network, a public network such as the Internet, a wireless local area network, and/or a public cellular network). In the exemplary embodiment shown in FIG. 1, each server computer 124 comprises one or more network interface 135 that is configured to communicatively couple the server computer 124 to a network such as an Ethernet local area network (that, in turn, is communicatively coupled to a public network such as the Internet). Also, each of the responder mobile devices 126 and responder mobile devices 130 comprises a wireless transceiver 134 that is configured to communicatively couple the server computer 124 to a network such as a wireless local area network or a public cellular network (that is, in turn is communicatively coupled to a public network such as the Internet). Each of the responder mobile devices 126 and responder mobile devices 130 is able to communicate with the server computer 124 by communicating over one or more networks.

Also, some of the devices on which the software 118, 120, and 122 executes can be deployed in a virtual environment using one or more virtual machines. Other conventional hardware and software technology can be used to implement such devices and/or the software 118, 120, and 122.

In one implementation, the occupant and responder mobile software 120 and 122 comprises respective mobile applications (“mobile apps”) that are installed on the occupant and responder mobile devices 126 and 130. The occupant and responder mobile software 120 and 122 can be implemented in other ways (for example, as a web site or web application or software that is remotely installed and/or executed on a mobile device 126 or 130, for example, using over-the-air update technology). Also, it is to be understood that the occupant and responder mobile software 120 and 122 need not be implemented in the same way.

In the exemplary embodiment shown in FIG. 1, the server software 118 is described here as being implemented separately from the occupant mobile software 120, the responder mobile software 122, and the BIM software for which the digital 3D model 106 was originally generated. However, it is to be understood that the indoor location system 100 can be implemented in other ways. For example, the indoor location system 100 can be implemented in a way that the functions described here as being implemented by the server software 124 are implemented at least in part as a part of the BIM software, the occupant software 120, and/or the responder software 122 so that no (or different) server software 118 is used.

In the exemplary embodiment shown in FIG. 1, each occupant and responder mobile device 126 and 130 further comprises one or more user input/output components 136 by which the respective user (that is, occupant 128 or responder 132) can provide user input to the software 120 and 122 and by which the software 120 and 122 can display or otherwise provide output to the user. More specifically, in the exemplary embodiment shown in FIG. 1, the one or more user input/output components 136 of both the mobile devices 126 and 130 comprise a touch screen 138. It is to be understood, however, that other user input/output components 136 can be used. Moreover, it is to be understood that the inertial sensors 144 (described below) can also be used for user input (for example, by having the user move the mobile device in predetermined ways).

In the exemplary embodiment shown in FIG. 1, each occupant and responder mobile device 126 and 130 further comprises one or more cameras 140 to capture image data, a GPS receiver 142 to receive GPS signals, and a set of inertial sensors 144 (for example, accelerometers and gyroscopes) to sense movement of the respective mobile device 126 and 130. As described below, the inertial sensors 144, and the data about the movement of the mobile device 126 or 130, generated using them, can be used to assist in determining the location of the mobile device 126 or 130 (for example, using dead-reckoning techniques) and/or for properly orienting an augmented reality (AR) display on the touchscreen 138 (or other display component).

As noted above, it is to be understood that the occupant and responder mobile devices 126 and 130 need not be implemented in the same way.

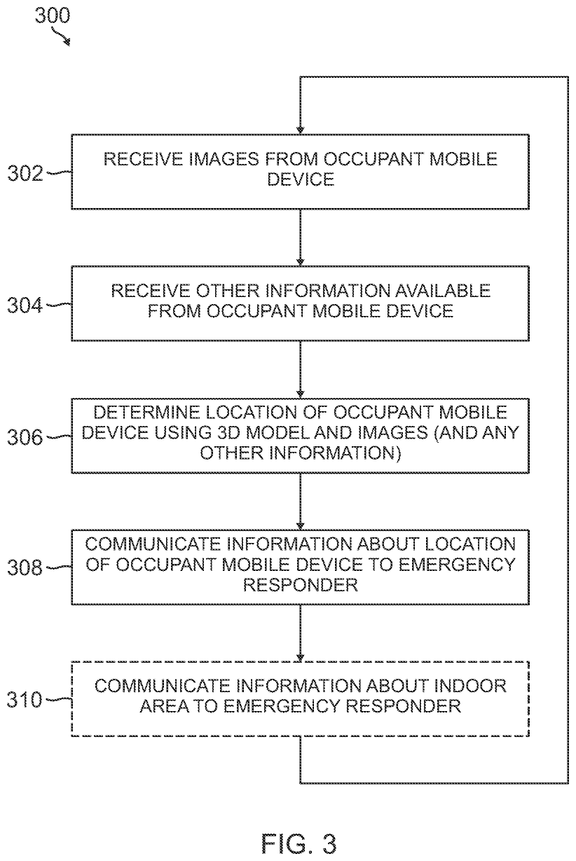

The indoor location system 100 is configured to determine the location of an occupant mobile device 126 (and the occupant 128 using that device 126) and providing information about that location to one or more responder mobile devices 130 (for example, so that the emergency responders 132 can find the occupant and provide emergency services to the occupant). This location can be determined without requiring use of the GPS receiver 142 of the occupant mobile device 126. The indoor location system 100 is configured to do this, generally, by receiving one or more images captured using at least one of the cameras 140 of the occupant mobile device 126, determining the location of the occupant mobile device 126 within the indoor area 102 using the one or more images and the digital 3D model 106 of the indoor area 102, and communicating information about the location of the occupant mobile device 126 (and the associated occupant 128) to one or more emergency responders 132 by communicating the information to the associated responder mobile devices 130. One example of how this can be done is described below in connection with FIG. 3.

FIG. 3 comprises a high-level flowchart illustrating one exemplary embodiment of a method 300 of determining a location of a mobile device 126 associated with an occupant 128 within an indoor area 102. The embodiment of method 300 shown in FIG. 3 is described here as being implemented using the embodiment of the indoor location system 100 described above in connection with FIG. 1, though other embodiments can be implemented in other ways.

The blocks of the flow diagram shown in FIG. 3 have been arranged in a generally sequential manner for ease of explanation; however, it is to be understood that this arrangement is merely exemplary, and it should be recognized that the processing associated with method 300 (and the blocks shown in FIG. 3) can occur in a different order (for example, where at least some of the processing associated with the blocks is performed in parallel and/or in an event-driven manner). Also, most standard exception handling is not described for ease of explanation; however, it is to be understood that method 300 can and typically would include such exception handling.

The embodiment of method 300 shown in FIG. 3 is described here as being performed to locate a particular occupant 128 and associated occupant mobile device 126, which is referred to here as the “current” occupant 128 and “current” occupant mobile device 126, respectively.

Method 300 comprises receiving one or more images captured using at least one camera 140 of the current occupant mobile device 126 (block 302). Also, in the exemplary embodiment shown in FIG. 2, method 200 further comprises receiving other information captured using the current occupant mobile device 126 (block 304).

In one example, the occupant mobile software 120 executing on the occupant mobile device 126 causes one or more images to be captured using at least one camera 140 of the current occupant mobile device 126. The occupant mobile software 120 receives them from the camera 140 and communicates them to the server computer 124, where they are received by the server software 118.

In this example, the occupant mobile software 120 executing on the occupant mobile device 126 also captures inertial sensor information and location information available to the occupant mobile device 126. The inertial sensor information can be used to determine the orientation of the occupant mobile device 126 when each image was captured. The location information available to the occupant mobile device 126 can include, for example, cellular triangulation data, GPS data received via the GPS receiver 142, and information about any communication networks or wireless beacons the occupant mobile device 126 is able to communicate with. While this available location information may not have sufficient precision for use by emergency responders, the precision may be sufficient to confirm that the occupant 128 is within the indoor area 102 and to do a coarse localization to expedite the precise location determination described below (for example, by reducing the relevant search space).

Method 300 further comprises determining the location of the occupant mobile device 126 (and the associated occupant 128) within the indoor area 102 using the one or more captured images and the digital 3D model 106 of the indoor area 102 (block 306). In the example shown in FIG. 3, other information captured using the occupant mobile device 126 is also used in this determination.

In the example described here in connection with FIG. 1, the server software 118 includes feature recognition software 146 that is configured to recognize one or more features in the captured images and search the feature information 114 of the digital 3D model 106 to find those features and the location of those features in the indoor space 102. The server software 118 can then use the detected features and their locations to determine the location of the current occupant mobile device 126 (and by extension the current occupant 128) using triangulation or other geospatial processing techniques.

The inertial sensor information can be used to determine the orientation of the occupant mobile device 126 when each image was captured, which can be used in the feature recognition and search process. Also, as noted above, the location information, if available, is used to confirm that the occupant 128 is within the indoor area 102 and to do a coarse localization to expedite the precise location determination described below (for example, by reducing the relevant search space).

Method 300 further comprises communicating information about the location of the occupant mobile device 126 to an emergency responder 132 (block 308). This information can be communicated to the emergency responder 132 by communicating it to the responder mobile device 126 used by that emergency responder 132.

The type of information about the location of the occupant mobile device 126 can take many forms. For example, information about the location of the occupant mobile device 126 can comprise X, Y, Z information for that location within a coordinate system (for example, a coordinate system used within the digital 3D model 106). The information about the location of the occupant mobile device 126 can also comprise identifiers for (or descriptions of) one or more visible landmarks (or other features) in the indoor area 102 and relative location information (for example, ranges measured relative to each of the landmarks). In one example, such location information can indicate, for example, that the occupant mobile device 126 (and the associated occupant 128) is 5 feet from the left-most elevator door on the second floor.

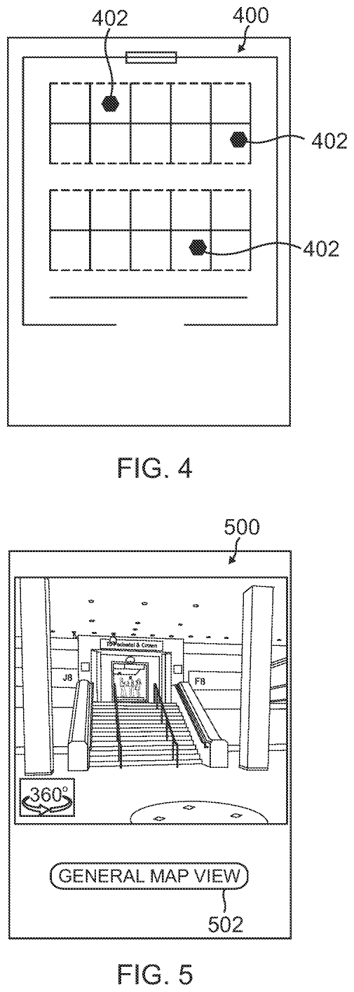

The information about the location of the occupant mobile device 126 can also comprise navigation information indicating how the emergency responder 132 can travel to the current occupant 128. One example of how this can be done is described below in connection with FIG. 4.

Method 300, optionally, further comprises communicating information about the indoor area 102 to the emergency responder 132 (block 310). This information can be communicated to the emergency responder 132 by communicating it to the responder mobile device 126 used by that emergency responder 132.

The type of information about the indoor area 102 can take many forms. For example, information about the indoor area 102 can comprise information for displaying a three-hundred sixty (360) degree panoramic view of the indoor area 102 on the mobile device 126 used by the emergency responder 132. One example of how this can be done is described below in connection with FIG. 5. This can be done prior to the emergency responder 132 entering the indoor area 102 and/or while the emergency responder 132 is traveling through the indoor area 102.

Method 300 can be performed repeatedly in order to track the movements of the emergency responder 132 and/or the occupant 128 and update the information about the location of the occupant mobile device 126 provided to the emergency responder 132.

By employing method 300, features in images captured by an occupant mobile device 126 can be recognized and located using a digital 3D model 106 of the indoor area 102. The occupant mobile device 126, and the associated occupant 128, can then be located relative to the located features using triangulation or other geospatial processing techniques. In this way, the location of the occupant 128 can be determined in situations where other location technology such as GPS or cellular triangulation does not work or provide the desired precision. This approach is especially well-suited for use in situations where a digital 3D model 106 is being generated for other purposes (for example, for use in a BIM system to plan, design, construct, and/or manage the building 104 of which the indoor area 102 is a part). In these situations, the digital 3D model 106 can be leveraged to also assist in locating occupants 128 within the building 104.

Method 300 can be performed as a targeted “find occupant” operation to locate a particular occupant 128 (and associated occupant mobile device 126). This can be done, for example, where the occupant 128 has initiated the execution of method 200 (for example, by interacting with the occupant mobile software 120 executing on the current occupant mobile device 126). This can be done as a part of a request for emergency services to be provided to that occupant 128.

Method 300 can also be performed as a global “find all” operation to locate all occupants 128 (and associated occupant mobile devices 126) that are located within the indoor area 102. This can be done, for example, so that the emergency responders 132 can manage the evacuation of the indoor area 102 by identifying all occupants 128, identifying their locations, and tracking their progress in evacuating the indoor area 102. The emergency responders 132 can assistant those occupants 128 that are not making appropriate progress in evacuating the indoor area 102.

Method 300 can be performed as a part of other operations.

One example of how the locations of the current occupants 128 can be displayed for an emergency responder 132 is shown in FIG. 4. In the example shown in FIG. 4, a two-dimensional map 400 of at least a portion of the indoor area 102 is annotated with the locations 402 of the mobile device 126 of the current occupants 128. The responder mobile software 122 is configured to display the map 400 with the annotations on the touch screen 138 of the responder mobile device 130 and allow the emergency responder 132 to zoom in and out and pan around the map 400. The responder mobile software 122 is configured to update the annotations for the locations 402 of the occupant mobile devices 126 as the occupants 128 move.

In one example, the responder mobile software 122 is configured so that if the emergency responder 132 clicks on the location 402 of an occupant mobile device 126, a route from the location of the emergency responder 132 to that occupant mobile device 126 is determined and information about that route is displayed for the emergency responder 132. Examples of how this can be done are described below in connection with FIGS. 5-7.

In this example, the responder mobile software 122 is also configured so that if the emergency responder 132 clicks on a location in the 2D map 400 other than a location of an occupant mobile device 126, information about the portion of the indoor area 102 near that location is displayed for the emergency responder 132. More specifically, if the emergency responder 132 clicks on a location in the 2D map 400 other than a location of an occupant mobile device 126, a 360 degree panoramic view of the area near that location is displayed on the touch screen 138 of the responder mobile device 130 instead of the annotated 2D map 400 shown in FIG. 4. One such example is shown in FIG. 5.

In the example shown in FIG. 5, a panoramic image 500 of the part of the indoor area 102 near the location clicked on by the emergency responder 132 is displayed on the touch screen 138 of the responder mobile device 130. The responder mobile software 122 is configured to display the image 500 and allow the emergency responder 132 to zoom in and out and pan around the displayed image 500, as well as allowing the emergency responder 132 to rotate (and update) the displayed image 500 to view a different part of the indoor area 102. The emergency responder 132 can do this in order to familiarize himself or herself with the indoor area 102. This can be done prior to the emergency responder 132 entering the indoor area 102 and/or while the emergency responder 132 is traveling through the indoor area 102.

In the example shown in FIG. 5, a button 502 is displayed that the emergency responder 132 can click on in order to have the annotated 2D map view shown in FIG. 4 displayed on the touch screen 138 of the responder mobile device 130 instead of 360 degree panoramic view shown in FIG. 5.

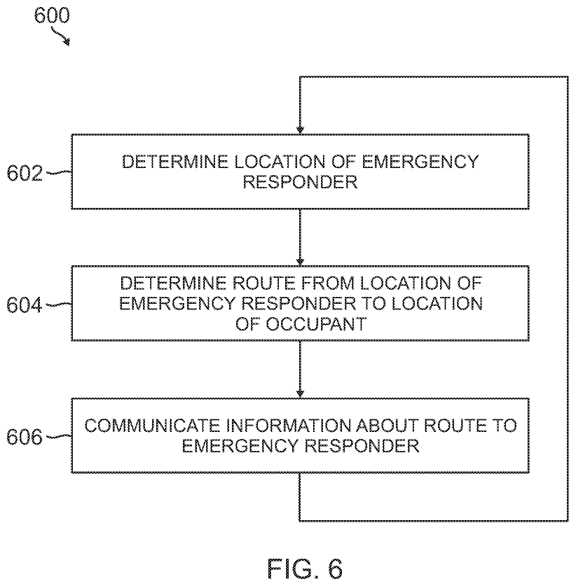

FIG. 6 comprises a high-level flowchart illustrating one example of a method 600 of determining route information to the location of an occupant mobile device 126 for an emergency responder 132. Method 600 is suitable for use with method 300 of FIG. 3.

The blocks of the flow diagram shown in FIG. 6 have been arranged in a generally sequential manner for ease of explanation; however, it is to be understood that this arrangement is merely exemplary, and it should be recognized that the processing associated with method 600 (and the blocks shown in FIG. 6) can occur in a different order (for example, where at least some of the processing associated with the blocks is performed in parallel and/or in an event-driven manner). Also, most standard exception handling is not described for ease of explanation; however, it is to be understood that method 600 can and typically would include such exception handling.

Method 600 comprises determining a location of the emergency responder 132 (block 602). This can be done using a mobile device 130 used by the emergency responder 132. For example, the responder mobile software 122 executing on the responder mobile device 130 can be configured to have the emergency responder 132 manually enter his or her location (for example, by displaying a 2D map of the interior area 102 on the touchscreen 138 of the responder mobile device 130 and prompting the emergency responder 132 to “click” where he or she is currently located). In another example, the responder mobile software 122 is configured to determine the location of the responder mobile device 130 automatically using the technique described above in connection with blocks 302-306 of FIG. 3.

In this example, the responder mobile software 122 communicates information indicating the location of the emergency responder 132 and the responder mobile device 130 to the server computer 124, where they are received by the server software 118.

Method 600 further comprises determining a route from the location of the emergency responder 132 to the location of the occupant mobile device 126 using the digital 3D model 106 of the indoor area 102 (block 604) and communicating information about the route to the emergency responder 132 (block 606). Method 600 can be performed repeatedly in order to track the movements of the emergency responder 132 and/or the occupant 128 and update the information about the route provided to the emergency responder 132.

In the example described here in connection with FIG. 1, the server software 118 includes path-finding software 148 that is configured to determine a suitable route using the path information 116 included in the digital 3D model 106. Once a suitable route is determined, information about the route can be communicated from the server software 118 to the responder mobile device 130. The responder mobile software 122 can then receive the information and display it on the touch screen 138 for viewing by the emergency responder 132.

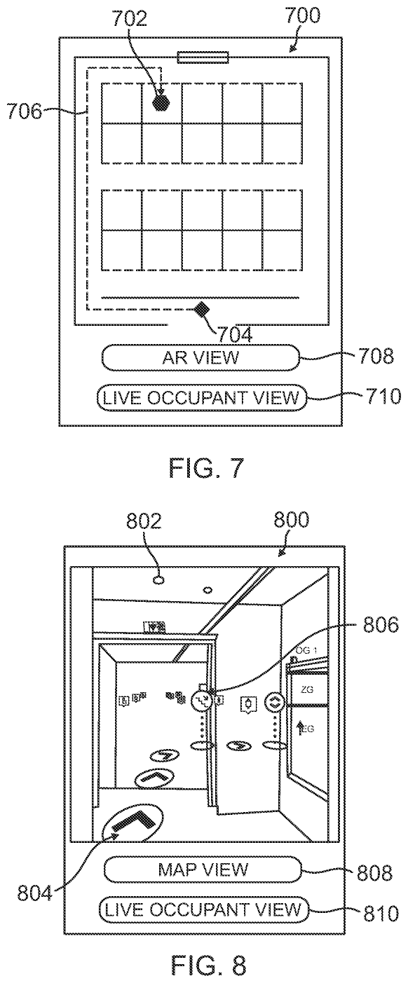

The information about the route can, for example, include information for displaying a two-dimensional image of the route annotated with the location of the occupant mobile device 126 and the location of the responder mobile device 130. One such example is shown in FIG. 7. In the example shown in FIG. 7, a two-dimensional map 700 of at least a portion of the indoor area 102 is annotated with the location 702 of the occupant mobile device 126, the location 704 of the responder mobile device 130, and the route 706 from the location 704 of the responder mobile device 130 to the location 702 of the occupant mobile device 126. The responder mobile software 122 is configured to display the map 700 with the annotations on the touch screen 138 of the responder mobile device 130 and allow the emergency responder 132 to zoom in and out and pan around the map 700. The responder mobile software 122 is configured to update the annotations for the location 702 of the occupant mobile device 126, the location 704 of the responder mobile device 130, and/or the route 706 from the location 704 of the responder mobile device 130 to the location 702 of the occupant mobile device 126 as the emergency responder 132 and/or the occupant 128 move and/or the route 706 is revised based on such movement.

In the example shown in FIG. 7, a button 708 is displayed that the emergency responder 132 can click on in order to have the AR view shown in FIG. 8 displayed on the touch screen 138 of the responder mobile device 130 instead of the annotated 2D map 700 shown in FIG. 7. Also, a button 710 is displayed that the emergency responder 132 can click on in order to have live images captured by the occupant mobile device 126 displayed on the touch screen 138 of the responder mobile device 130 instead of the annotated 2D map 700 shown in FIG. 7.

In another example, the information about the route can include information for displaying an augmented reality (AR) view of the indoor area 102 that superimposes route information on a live image of the area currently being captured by one or more cameras 140 of the responder mobile device 130. One such example is shown in FIG. 8. In the example shown in FIG. 8, information is communicated to the responder mobile device 130 that enables the responder mobile software 122 to display an AR view 800 that superimposes various annotations over a live image 802 that is currently being captured by one or more cameras 140 included in the responder mobile device 130. The AR view 800 includes a series of arrows 804 that depicts where the emergency responder 132 should follow to travel to the occupant 128 along the route. In this example, the AR view 800 also includes a “stairs” annotation 806 indicating that the emergency responder 132 should walk down the stairs in order to follow the route to the occupant 128.

As the emergency responder 132 moves, the displayed live image 802 is updated to reflect what can currently be “seen” by the camera 140 and the AR view 800 is updated to reflect the current position of the emergency responder 132.

In the example shown in FIG. 8, a button 808 is displayed that the emergency responder 132 can click on in order to have the annotated 2D map 700 shown in FIG. 7 displayed on the touch screen 138 of the responder mobile device 130 instead of the AR view 800 shown in FIG. 8. Also, a button 810 is displayed that the emergency responder 132 can click on in order to have live images captured by the occupant mobile device 126 displayed on the touch screen 138 of the responder mobile device 130 instead of the AR view 800 shown in FIG. 8.

Methods 300 and 600 can be repeated in order to update the displayed route information in real-time (or near real-time) (for example, by updating the current location of the occupant 128 and the emergency responder 132). By displaying such up-to-date route information on a touchscreen 138 (or other user input/output component) of the responder mobile device 130, the emergency responder 132 can be guided to the current occupant 128 in a convenient and efficient manner, which is especially well-suited for use in emergency situations.

The indoor location system 100 described above can be used for other purposes. For example, the indoor location system 100 can be used to track the location of mobile devices 126 associated with occupants 128 of the building 104 for mitigating infectious diseases such as severe acute respiratory syndrome (SARS), Middle East respiratory syndrome (MERS), or coronavirus disease 19 (COVID-19). This can include tracking and tracing the contacts of occupants 128 of the building 104 and providing real-time alerts when social distancing policies are not be compiled with.

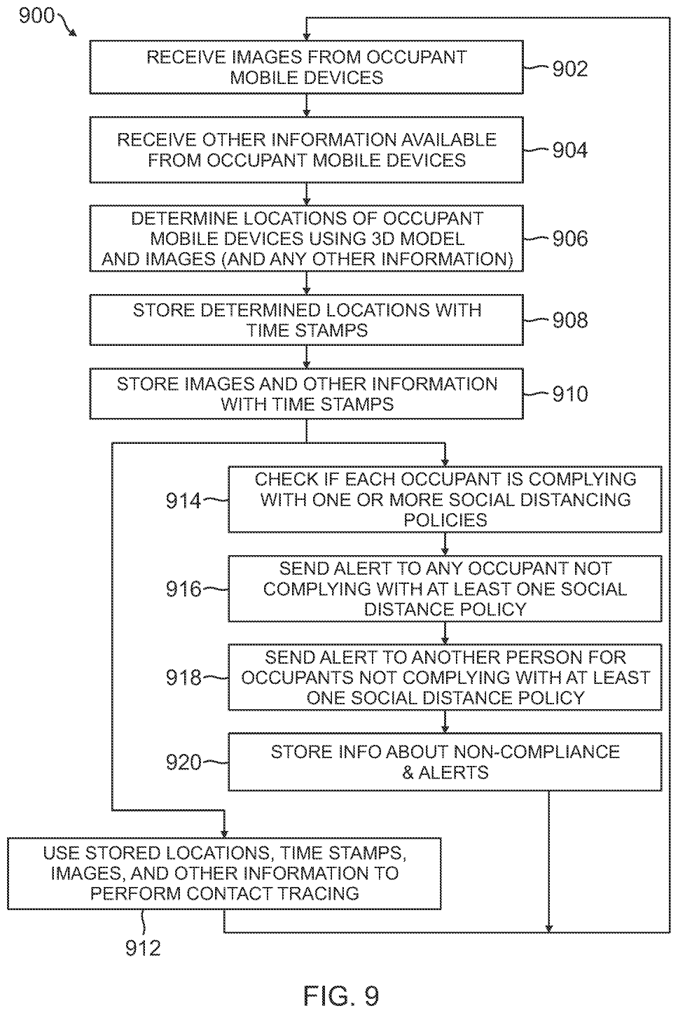

FIG. 9 comprises a high-level flowchart illustrating one exemplary embodiment of a method 900 of tracking the locations of mobile devices 126 associated with occupants 128 within an indoor area 102. The embodiment of method 900 shown in FIG. 9 is described here as being implemented using the embodiment of the indoor location system 100 described above in connection with FIG. 1, though other embodiments can be implemented in other ways.

The blocks of the flow diagram shown in FIG. 9 have been arranged in a generally sequential manner for ease of explanation; however, it is to be understood that this arrangement is merely exemplary, and it should be recognized that the processing associated with method 900 (and the blocks shown in FIG. 9) can occur in a different order (for example, where at least some of the processing associated with the blocks is performed in parallel and/or in an event-driven manner). Also, most standard exception handling is not described for ease of explanation; however, it is to be understood that method 900 can and typically would include such exception handling.

In this embodiment, each occupant 128 of the indoor area 102 (that is, within the building 104) is required to have the occupant mobile software 120 installed and running on the occupant's mobile device 126 while the occupant 128 is within the building 104. The embodiment of method 900 is based on the assumption that the location of a mobile device 126 will tend to be highly correlated with the location of the associated occupant 128 who uses that mobile device 126 (because most occupants 128 tend to carry their mobile devices 126 with them at all times as they travel within the inside area 102). Thus, tracking the location of the mobile device 126 can be used to track the location of the associated occupant 128 using that mobile device 126.

Method 900 comprises receiving one or more images captured using at least one camera 140 of each occupant mobile device 126 in the indoor area 102 (block 902), receiving other information captured using each current occupant mobile device 126 (block 904), and determining the location of each occupant mobile device 126 (and the associated occupant 128) within the indoor area 102 using the one or more captured images and the digital 3D model 106 of the indoor area 102 (block 906). The processing of blocks 902, 904, and 906 is performed as described above in connection with blocks 302, 304, and 306, respectively, of method 300 shown in FIG. 3, the description of which is not repeated here for the sake of brevity.

Each determined location of each occupant mobile device 126 for each occupant 128 within the indoor area 102 is time stamped (that is, the time when the location determination was performed is captured and associated with the location).

In the example shown in FIG. 9, other information captured using the occupant mobile devices 126 can also be used in this location determination. Examples of this other information includes, for example, inertial sensor information and location information (such as cellular triangulation data, GPS data received via the GPS receiver 142, and information about any communication networks or wireless beacons the occupant mobile device 126 is able to communicate with).

Method 900 further comprises storing the determined locations of the occupant mobile device 126 of each occupant 128 of the indoor area 102 along with the associated time stamp (block 908) and, optionally, storing the captured images and other information used in the determination of the location of the occupant mobile device 126 of each occupant 128 along with the associated time stamp (block 910). Also, an identifier for each occupant mobile device 126 and/or an identifier for the user (occupant) of each mobile device 126 can also be stored with the location, time stamp, image, and other information. Examples of identifiers include an International Mobile Equipment Identity (IMEI) or other device identifier assigned to the mobile device 126 and the legal name of the occupant 128, a Social Security Number (or other government-assigned identifier) assigned to the occupant 128, or a username selected by the occupant 128. If the identifier is an identifier for the occupant 128 using each mobile device 126, the occupant mobile software 120 can also be configured to have the user enter an identifier for the user when the occupant mobile software 120 is first installed on the mobile device 128. The occupant mobile software 120 can also be configured to have the occupant 128 subsequently confirm the identity of the person using the occupant mobile device 126 (for example, each time the occupant mobile software 120 runs or after a predetermined amount of time has elapsed since the identity of the person using the occupant mobile device 126 was last confirmed). In some implementations, only an identifier for the mobile device 126 is stored (and not an identifier for the user using the mobile device 126). In such implementations, an identifier for an occupant 128 can be determined, if needed, when contact tracing is performed, in which case an association between the identifier for the occupant 128 and the identifier for the occupant's mobile device 126 can be determined at that time and the relevant stored information can be retrieved using the identifier for the occupant's mobile device 126. In one implementation, the location, time stamp, image, identifier, and other information are stored by the server computer 124.

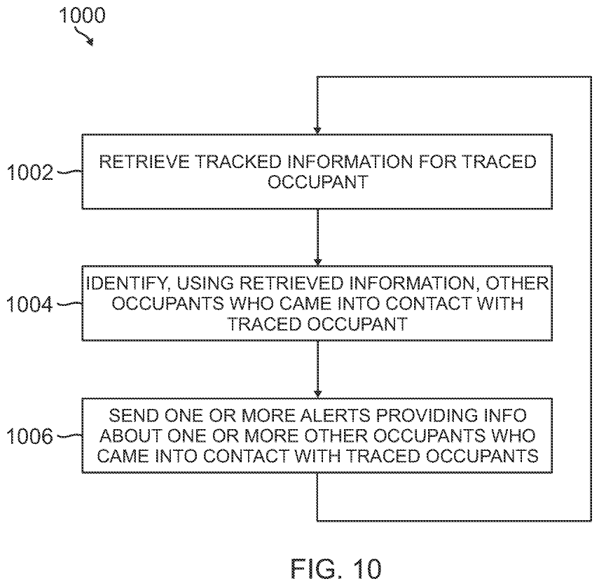

At least some of the stored location, time stamp, image, identifier, and other information can then be used in performing contact tracing for one or more of the occupants 128 (block 912). For example, contact tracing can be performed in response to an occupant testing positive for an infectious distance such as COVID-19. One example of how such contact tracing can be performed is described below in connection with FIG. 10.

In the exemplary embodiment shown in FIG. 9, method 900 further comprises using the current location of each occupant mobile device 126 within the indoor area 102 to check if that location indicates that the occupant 128 using that mobile device 126 is complying with one or more social distancing policies applicable to the indoor area 102 (block 914). In the example shown in FIG. 9, this is done in real-time so that an alert (such as a text message) can be sent to the occupant mobile device 126 of any occupant 128 that is not complying with at least one social distancing policy (block 916) and/or sent to the mobile device of another person (for example, building security) (block 918). The alert can explain how the location of the occupant mobile device 126 indicates that the occupant 128 using that mobile device 126 is not complying with the applicable social distancing policies and what the occupant 128 should do to come into compliance with the applicable social distancing policies.

For example, the social distancing policies applicable to the indoor area 102 may require that each occupant 128 be separated from any other occupant 128 by a minimum distance (for example, 6 feet). If the locations of any occupant mobile devices 126 indicate that the associated occupants 128 are not separated from each other by the minimum distance, then alerts can be sent to the involved mobile devices 126 and/or to building security. In one implementation, alerts are sent only after the non-compliance exists for a minimum amount of time (for example, one minute).

By providing real-time alerts in response to detected non-compliance with social distancing policies applicable to the indoor area 102, the users of the involved mobile devices 126 and/or the other person to whom the alert is sent (for example, building security), can take immediate steps to come into compliance with the applicable social distancing policies.

In the exemplary embodiment shown in FIG. 9, method 900 further comprises storing information about any non-compliance with the social distancing policies applicable to the indoor area 102 and any alerts sent in response thereto along with associated time stamps (block 920). Identifiers for the relevant occupant mobile devices 126 and/or identifiers for the occupants 128 using the relevant mobile devices 126 can also be stored with the non-compliance, alert, and time stamp information. In one implementation, the non-compliance, alert, time stamp, and identifier information is stored by the server computer 124. The stored non-compliance, alert, time stamp, and identifier information can later be used in tracing the contacts of occupants 128 (for example, when an occupant tests positive for an infectious distance such as COVID-19). One example of how such contact tracing can be performed is described below in connection with FIG. 10.

FIG. 10 comprises a high-level flowchart illustrating one exemplary embodiment of a method 1000 of tracing contacts of a person who was an occupant 128 of an indoor area 102. The embodiment of method 1000 shown in FIG. 10 is described here as being implemented using the information tracked using method 900, though other embodiments can be implemented in other ways.

The blocks of the flow diagram shown in FIG. 10 have been arranged in a generally sequential manner for ease of explanation; however, it is to be understood that this arrangement is merely exemplary, and it should be recognized that the processing associated with method 1000 (and the blocks shown in FIG. 10) can occur in a different order (for example, where at least some of the processing associated with the blocks is performed in parallel and/or in an event-driven manner). Also, most standard exception handling is not described for ease of explanation; however, it is to be understood that method 1000 can and typically would include such exception handling.

Method 1000 can be performed when a person who was an occupant 128 of an indoor area 102 tests positive for an infectious disease (such as COVID-19) or otherwise has an elevated risk of infection from the infectious disease (for example, because the occupant 128 has been exposed to someone who is or was infected). This person is referred to here as an “traced occupant” 128. The traced occupant 128 can also be another occupant 128 who was identified as “coming into contact” with another traced occupant 128.

Method 1000 comprises retrieving tracking information stored for a traced occupant 128 during the period of interest (block 1002). In this embodiment, not all of the tracking information for the traced occupant 128 is retrieved but only the tracked information for a particular limited period (referred to here as the “period of interest”). In this embodiment, the “period of interest” can correspond to the quarantine period used for the infectious disease (that is, the number of days between when a person is first infected with the infectious disease and when that person would first be expected to be incapable of transmitting the infectious disease to others). Other periods of interest can be used such as the incubation period for the infectious disease (that is, the number of days between when a person is first infected with the infectious disease and when that person would first be expected to show symptoms of the infectious disease).

As noted above in connection with FIG. 9, an identifier for each occupant mobile device 126 and/or an identifier for the occupant 128 using each mobile device 126 can be stored with the location, time stamp, image, and other information. In such embodiments, the identifier for the traced occupant's mobile device 126 and/or the identifier for the traced occupant 128 can be determined and then used to retrieve tracking information stored for the traced occupant 128. For example, in one implementation, only an identifier for each occupant mobile device 126 is stored with the tracked location, time stamp, image, and other information. In such an implementation, when it is necessary to use method 1000 to trace the contacts of a person who was an occupant 128 of an indoor area 102, the identifier for the traced occupant's mobile device 126 can be determined and then used to retrieve tracking information stored for the traced occupant 128.

Method 1000 further comprises identifying, using the traced occupant's retrieved tracking information, all other occupants 128 of the indoor area 102 who “came into contact” with the traced occupant 128 while the traced occupant 128 was in the indoor area 102 during the period of interest (block 1004). It should be noted that the “contact” referred to in the phrase “came into contact” can include social contact and does not require physical contact. Also, it should be noted that the determination of other occupants 128 who came into contact with the traced occupant 128 using the tracking information is based on the assumption, noted above, that the location of a mobile device 126 will tend to be highly correlated with the location of the associated occupant 128 who uses that mobile device 126 and, therefore, that the location of the mobile device 126 can be used to track the location of the associated occupant 128 using that mobile device 126.

The determination of who “came into contact” with the traced occupant 128 while the traced occupant 128 was in the indoor area 102 is a function of where the traced occupant 128 was located in the indoor area 102 during the period of interest as indicated by the location of the traced occupant's mobile device 126. For example, in one implementation, any other occupant 128 who was “near” the traced occupant 128 during the period of interest (as indicated by the tracked location of that occupant's mobile device 126) is considered to have come into contact with the traced occupant 128. That is, an occupant 128 is considered to have come into contact with the traced occupant 128 if, for a given point in time (determined from the time stamps associated with the traced occupant's tracking information), the distance between the location of the traced occupant's mobile device 126 and the location of the other occupant's mobile device 126 is less than a predetermined distance (for example, less than 6 feet). To account for exposure that may occur after the traced occupant 128 leaves a tracked location (for example, exposure resulting from contact with contaminated surfaces or other forms of lingering virus), this distance check can be performed for an additional period after the traced occupant 128 left each location. In such an implementation, a respective contact region can be defined for each tracked location of the traced occupant 128 (as indicated by the location of the traced occupant's mobile device 126). The contact region can be defined as a circle centered at that tracked location and having a radius that corresponds to the predetermined distance being used. That is, another occupant 128 is considered to have come into contact with the traced occupant 128 if the other occupant's mobile device 126 was located within the contact region while the traced occupant's mobile device 126 was at that associated location or within a predetermined period after the traced occupant's mobile device 126 left the associated location. This determination can be performed by first retrieving all tracked information stored for the mobile devices 126 of all occupants 128 for the period of interest and then, for each location that the traced occupant's mobile device 126 occupied in the indoor area 102, searching the retrieved tracked information to identify all other mobile devices 126 that were located in the contact region defined for each such location while the traced occupant's mobile device 126 was at that location or within a predetermined period after the traced occupant's mobile device 126 left that location (as indicated by the time stamps).

In other embodiments, the determination of who came into contact with the traced occupant 128 while the infected person was in the indoor area 102 is implemented in other ways.

Method 1000 further comprises sending one or more alerts providing information about one or more of the other occupants 128 who came into contact with the traced occupant 128 while the traced occupant 128 was in the indoor area 102 during the period of interest (block 1006). For example, an alert can comprise a message that identifies all other occupants 128 who came into contact with the traced occupant 128 while the traced occupant 128 was in the indoor area 102 during the period of interest, where the message is sent to a third party (for example, a team of contact tracers) who will contact each of the other occupants 128 and inform that occupant 128 about the contact with the traced occupant 128 and any measures that should be taken in response to such contact (for example, testing for the infectious disease and/or quarantining the occupant 128). In such an example, the message can identify all other occupants 128 who came into contact with the traced occupant 128 using, for example, an identifier for each occupant mobile device 126 and/or an identifier for the occupant 128 using each mobile device 126 stored with the tracking information. In another example, the alerts comprise a set of messages that are sent to the mobile devices 126 of the other occupants 128 who came into contact with the traced occupant 128 while the traced occupant 128 was in the indoor area 102 during the period of interest, where each other occupant 128 is sent a respective message that informs that particular occupant 128 about the contact with the traced occupant 128 and any measures that should be taken in response to such contact. In some embodiments, the alerts include tracked information, or information derived from the tracked information, such as locations where the contact occurred, the duration of the contact, and/or images that were captured (for example, by the other occupant's mobile device or the the traced occupant's mobile device). The alert can be sent in other ways.

Method 1000 can then be performed for each other occupant 128 of the indoor area 102 who came into contact with the traced occupant 128 during the period of interest, where that other occupant 128 is considered the “traced occupant” 128 for the purposes of that iteration of method 1000. Method 1000 can be performed repeatedly for each unique occupant 128 that came into contact with any traced occupant 128 (including the original traced occupant 128 or any traced occupant 128 identified by the contact tracing performed by one of the iterations of method 1000).

Methods 900 and 1000 can be used to perform contact tracking and tracing for an infectious disease in indoor environments without requiring the use of a GPS receiver.

The various features described above can be implemented in hardware, software, or combinations of hardware and software, and the various implementations (whether hardware, software, or combinations of hardware and software) can also be referred to generally as “circuitry” or a “circuit” or “circuits” configured to implement at least some of the associated functionality. When implemented in software, such software can be implemented in software or firmware executing on one or more suitable programmable processors or configuring a programmable device (for example, processors or devices included in or used to implement special-purpose hardware, general-purpose hardware, and/or a virtual platform). Such hardware or software (or portions thereof) can be implemented in other ways (for example, in an application specific integrated circuit (ASIC), etc.). Such features can be implemented in other ways.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

### EXAMPLE EMBODIMENTS

Example 1 includes a method of determining a location of a mobile device associated with an occupant within an indoor area, the method comprising: receiving one or more images captured using at least one camera of the mobile device; determining the location of the mobile device within the indoor area using the one or more images and a digital three-dimensional model of the indoor area; and communicating information about the location of the mobile device to an emergency responder.

Example 2 includes the method of Example 1, further comprising communicating the one or more images to server software, wherein the server software is configured to determine the location of the mobile device within the indoor area using the one or more images and the digital three-dimensional model of the indoor area.

Example 3 includes the method of any of Examples 1-2, wherein the method is performed in order to determine the respective locations of a plurality of occupant mobile devices within the indoor area using one or more images captured using the occupant mobile devices and the digital three-dimensional model of the indoor area, where information about the locations of the plurality of occupant mobile devices to the emergency responder.

Example 4 includes the method of any of Examples 1-3, wherein the method is repeated to track the location of the mobile device used by the occupant.

Example 5 includes the method of any of Examples 1-4, wherein determining the location of the mobile device within the indoor area using the one or more images and the digital three-dimensional model of the indoor area comprises: recognizing one or more features in the one or more images; and searching the digital three-dimensional model of the indoor area for the one or more features.

Example 6 includes the method of any of Examples 1-5, wherein communicating the information about the location of the mobile device to the emergency responder comprises: determining a location of the emergency responder; determining a route from the location of the emergency responder to the location of the mobile device using the digital three-dimensional model of the indoor area; and communicating information about the route to the emergency responder.

Example 7 includes the method of Example 6, wherein the information about the route comprises information for displaying a two-dimensional image of the route, the location of the mobile device, and the location of the emergency responder.

Example 8 includes the method of any of Examples 6-7, wherein the information about the route comprises information for displaying an augmented reality (AR) view that superimposes route information on an image of an area currently being captured by a mobile device used by the emergency responder.

Example 9 includes the method of any of Examples 6-8, wherein determining the location of the emergency responder comprises determining the location of a mobile device used by the emergency responder; and wherein communicating the information about the route to the emergency responder comprises communicating the information about the route to the mobile device used by the emergency responder.

Example 10 includes the method of Example 9, wherein determining the location of the mobile device used by the emergency responder comprises: receiving one or more images captured using at least one camera of the mobile device used by the emergency responder; and determining the location of the mobile device used by the emergency responder using the one or more images captured using the mobile device used by the emergency responder and the digital three-dimensional model of the indoor area.

Example 11 includes the method of any of Examples 1-10, wherein the mobile device comprises at least one of a smartphone, smart watch, smart glasses, a tablet, and a laptop computer.

Example 12 includes the method of any of Examples 1-11, wherein the indoor area comprises an interior of a building.

Example 13 includes the method of any of Examples 1-12, further comprising: communicating information about the indoor area to the emergency responder.

Example 14 includes the method of Example 13, wherein the information about the indoor area communicated to the emergency responder comprises information for displaying a three-hundred sixty (360) degree panoramic view of the indoor area on a mobile device used by the emergency responder.

Example 15 includes a system for determining a location of a mobile device associated with an occupant within an indoor area, the system comprising: an occupant mobile device used by the occupant, the occupant mobile device configured to execute occupant mobile software and comprising at least one camera; and a responder mobile device used by an emergency responder, the responder mobile device configured to execute responder mobile software; wherein the occupant mobile software is configured to capture one or more images using at least one camera of the occupant mobile device; wherein the system is configured to determine the location of the responder mobile device within the indoor area using the one or more images and a digital three-dimensional model of the indoor area; and wherein the system is configured to communicate information about the location of the mobile device to the responder mobile device.

Example 16 includes the system of Example 15, further comprising a server computer configured to execute server software, wherein the one or more images are communicated to the server software, wherein the server software is configured to determine the location of the mobile device within the indoor area using the one or more images and the digital three-dimensional model of the indoor area.

Example 17 includes the system of Example 16, wherein the server software is at least one of: a part of a building information model system; and configured to communicate with the building information model system.

Example 18 includes the system of any of Examples 15-17, wherein the system is configured to determine the respective locations of a plurality of occupant mobile devices within the indoor area using one or more images captured using the occupant mobile devices and the digital three-dimensional model of the indoor area, where information about the locations of the plurality of occupant mobile devices to the emergency responder.

Example 19 includes the system of any of Examples 15-18, wherein the system is configured to repeatedly determine the location of the mobile device used by the occupant in order to track the movement of the mobile device.

Example 20 includes the system of any of Examples 15-19, wherein the system is configured to determine the location of the responder mobile device within the indoor area using the one or more images and the digital three-dimensional model of the indoor area by: recognizing one or more features in the one or more images; and searching the digital three-dimensional model of the indoor area for the one or more features.

Example 21 includes the system of any of Examples 15-20, wherein the system is configured to communicate information about the location of the mobile device to the responder mobile device by: determining a location of the responder mobile device; determining a route from the location of the responder mobile device to the location of the occupant mobile device using the digital three-dimensional model of the indoor area; and communicating information about the route to the responder mobile device.

Example 22. includes the system of Example 21, wherein the information about the route comprises information for displaying a two-dimensional image of the route, the location of the occupant mobile device, and the location of the responder mobile device.

Example 23 includes the system of any of Examples 21-22, wherein the information about the route comprises information for displaying an augmented reality (AR) view that superimposes route information on an image of an area currently being captured by the responder mobile device.

Example 24 includes the system of any of Examples 21-23, wherein determining the location of the responder mobile device comprises: receiving one or more images captured using at least one camera of the responder mobile device; and determining the location of the responder mobile device using the one or more images captured using the responder mobile device and the digital three-dimensional model of the indoor area.

Example 25 includes the system of any of Examples 15-24, wherein the occupant mobile device comprises at least one of a smartphone, smart watch, smart glasses, a tablet, and a laptop computer; and wherein the responder mobile device comprises at least one of a smartphone, smart watch, smart glasses, a tablet, and a laptop computer.

Example 26 includes the system of any of Examples 15-25, wherein the indoor area comprises an interior of a building.

Example 27 includes the system of any of Examples 15-26, wherein the system is configured to communicate information about the indoor area to the responder mobile device.

Example 28 includes the system of Example 27, wherein the information about the indoor area communicated to the responder mobile device comprises information for displaying a three-hundred sixty (360) degree panoramic view of the indoor area on the responder mobile device.

Example 29 includes a method of tracking locations of mobile devices associated with occupants within an indoor area, the method comprising: receiving one or more images captured using at least one camera of the respective mobile device associated with each occupant within the indoor area; determining the location of each mobile device within the indoor area using the respective one or more images and a digital three-dimensional model of the indoor area; storing each determined location of each occupant mobile device of each occupant of the indoor area along with an associated time stamp; and using at least some of the stored locations and time stamps in performing contact tracing.

Example 30 includes the method of Example 29, wherein contact tracing is performed in response to an occupant testing positive for an infectious distance.

Example 31 includes the method of any of Examples 29-30, further comprising storing captured images and other information used in determining each determined location of each occupant mobile device of each occupant of the indoor area along with an associated time stamp.

Example 32 includes the method of Example 31, wherein the locations, time stamps, captured images, and other information are stored by at least one server computer.

Example 33 includes the method of any of Examples 29-32, wherein storing each determined location of each occupant mobile device of each occupant of the indoor area along with an associated time stamp comprises: storing, along with each determined location of each occupant mobile device of each occupant of the indoor area along, at least one of an identifier for that occupant mobile device or an identifier associated with the occupant.

Example 34 includes the method of any of Examples 29-33, further comprising using the respective current location of the respective occupant mobile device of each occupant of the indoor area to check if that occupant is complying with one or more social distancing policies applicable to the indoor area.

Example 35 includes the method of Example 34, wherein using the respective current location of the respective occupant mobile device of each occupant of the indoor area to check if that occupant is complying with one or more social distancing policies applicable to the indoor area is done in real-time.

Example 36 includes the method of Example 35, further comprising at least one of: sending an alert to the respective occupant mobile device of an occupant that is not complying with one or more of the social distancing policies applicable to the indoor area; and sending an alert to a mobile device of another person in response to an occupant not complying with one or more of the social distancing policies applicable to the indoor area.

Example 37 includes the method of Example 36, wherein said other person to which at least one alert is sent comprises a building security person

Example 38 includes the method of any of Examples 36-37, wherein at least one alert includes information identifying a respective occupant not complying with one or more social distancing policies and what said occupant should do to come into compliance with the one or more social distancing policies.

Example 39 includes the method of any of Examples 36-38, further comprising storing information about any non-compliance with the social distancing policies established for the indoor area and any alerts sent in response thereto along with associated time stamps.

Example 40 includes the method of any of Examples 29-39, further comprising communicating the one or more images to server software, wherein the server software is configured to determine the location of each mobile device within the indoor area using the one or more images and the digital three-dimensional model of the indoor area.

Example 41 includes the method of any of Examples 29-40, wherein determining the location of each mobile device within the indoor area using the respective one or more images and the digital three-dimensional model of the indoor area comprises: recognizing one or more features in the one or more images; and searching the digital three-dimensional model of the indoor area for the one or more features.

Example 42 includes the method of any of Examples 29-41, wherein each mobile device comprises at least one of a smartphone, smart watch, smart glasses, a tablet, and a laptop computer.

Example 43 includes the method of any of Examples 29-42, wherein the indoor area comprises an interior of a building.

Example 44 includes the method of any of Examples 29-43, wherein using at least some of the stored locations and time stamps in performing contact tracing comprises: retrieving tracking information stored for a traced occupant during a period of interest; identifying, using the traced occupant's retrieved tracking information, all other occupants of the indoor area who came into contact with the infected person while the traced occupant was in the indoor area during the period of interest; and sending one or more alerts providing information about one or more of the other occupants who came into contact with the traced occupant while the traced occupant was in the indoor area during the period of interest.

Example 45 includes the method of Example 44, wherein the determination of who came into contact with the traced occupant while the traced occupant was in the indoor area is a function of where the traced occupant was located in the indoor area during the period of interest.

Example 46 includes the method of any of Examples 44-45, wherein sending said one or more alerts comprises sending a message that identifies all other occupants who came into contact with the traced occupant while the traced occupant was in the indoor area during the period of interest, wherein the message is sent to a third party who will contact the other occupants and inform the other occupants about the contact with the traced occupant and any measures that should be taken in response to said contact.

Example 47 includes the method of Example 46, wherein the third party comprises a team of contact tracers.

Example 48 includes the method of any of Examples 44-47, wherein sending said one or more alerts comprises sending a set of messages that are sent to the other occupants who came into contact with the traced occupant while the traced occupant was in the indoor area during the period of interest, where each other occupant is sent a respective message that informs that said each other occupant about the contact with the traced occupant and any measures that should be taken in response to such contact.

Example 49 includes the method of any of Examples 44-48, wherein at least one of the alerts include tracked information, or information derived from tracked information.

Example 50 includes the method of Example 49, wherein said tracked information, or said information derived from tracked information, comprises at least one of: locations where contact occurred, duration of contact, and images that were captured.

Example 51 includes a system for determining a location of mobile devices associated with occupants within an indoor area, the system comprising: occupant mobile devices used by the occupants, the occupant mobile devices configured to execute occupant mobile software and comprising at least one camera; and wherein the occupant mobile software executed by each occupant mobile device is configured capture one or more images using at least one camera of that occupant mobile device; wherein the system is configured to determine the location of each mobile device within the indoor area using the respective one or more images and a digital three-dimensional model of the indoor area; store each determined location of each occupant mobile device of each occupant of the indoor area along with an associated time stamp; and use at least some of the stored locations and time stamps in performing contact tracing.

Example 52 includes the system of Example 51, wherein the system is configured to perform contact tracing in response to an occupant testing positive for an infectious distance.

Example 53 includes the system of any of Examples 51-52, wherein the system is configured to store captured images and other information used in determining each determined location of each occupant mobile device of each occupant of the indoor area along with an associated time stamp.

Example 54 includes the system of Example 53, wherein the system further comprises at least one server computer configured to store the locations, time stamps, captured images, and other information.

Example 55 includes the system of any of Examples 51-54, wherein the system is further configured to store, along with each determined location of each occupant mobile device of each occupant of the indoor area along, at least one of an identifier for that occupant mobile device or an identifier associated with the occupant.

Example 56 includes the system of any of Examples 51-55, wherein the system is configured to use the respective current location of the respective occupant mobile device of each occupant of the indoor area to check if that occupant is complying with one or more social distancing policies applicable to the indoor area.

Example 57 includes the system of Example 56, wherein the system is configured to use the respective current location of the respective occupant mobile device of each occupant of the indoor area to check if that occupant is complying with one or more social distancing policies applicable to the indoor area in real-time.

Example 58 includes the system of Example 57, wherein the system is configured to do at least one of: send an alert to the respective occupant mobile device of an occupant that is not complying with one or more of the social distancing policies applicable to the indoor area; and send an alert to a mobile device of another person in response to an occupant not complying with one or more of the social distancing policies applicable to the indoor area.

Example 59 includes the system of Example 58, wherein said other person to which at least one alert is sent comprises a building security person

Example 60 includes the system of any of Examples 58-59, wherein the system is configured so that at least one alert includes information identifying a respective occupant not complying with one or more social distancing policies and what said occupant should do to come into compliance with the one or more social distancing policies.

Example 61 includes the system of any of Examples 58-60, wherein the system is configured to store information about any non-compliance with the social distancing policies established for the indoor area and any alerts sent in response thereto along with associated time stamps.

Example 62 includes the system of any of Examples 51-61, wherein the system is configured to communicate the one or more images to server software, wherein the server software is configured to determine the location of each mobile device within the indoor area using the one or more images and the digital three-dimensional model of the indoor area.

Example 63 includes the system of any of Examples 51-62, wherein the system is configured to determine the location of each mobile device within the indoor area using the respective one or more images and the digital three-dimensional model of the indoor area by doing the following: recognizing one or more features in the one or more images; and searching the digital three-dimensional model of the indoor area for the one or more features.

Example 64 includes the system of any of Examples 51-63, wherein each mobile device comprises at least one of a smartphone, smart watch, smart glasses, a tablet, and a laptop computer.

Example 65 includes the system of any of Examples 51-64, wherein the indoor area comprises an interior of a building.

Example 66 includes the system of any of Examples 51-65, wherein the system is configured to use at least some of the stored locations and time stamps in performing contact tracing by doing the following: retrieve tracking information stored for a traced occupant during a period of interest; identify, using the traced occupant's retrieved tracking information, all other occupants of the indoor area who came into contact with the infected person while the traced occupant was in the indoor area during the period of interest; and send one or more alerts providing information about one or more of the other occupants who came into contact with the traced occupant while the traced occupant was in the indoor area during the period of interest.

Example 67 includes the system of Example 66, wherein the determination of who came into contact with the traced occupant while the traced occupant was in the indoor area is a function of where the traced occupant was located in the indoor area during the period of interest.

Example 68 includes the system of any of Examples 66-67, wherein the system is configured to send said one or more alerts by sending a message that identifies all other occupants who came into contact with the traced occupant while the traced occupant was in the indoor area during the period of interest, wherein the message is sent to a third party who will contact the other occupants and inform the other occupants about the contact with the traced occupant and any measures that should be taken in response to said contact.

Example 69 includes the system of Example 68, wherein the third party comprises a team of contact tracers.

Example 70 includes the system of any of Examples 66-69, wherein the system is configured to send said one or more alerts by sending a set of messages that are sent to the other occupants who came into contact with the traced occupant while the traced occupant was in the indoor area during the period of interest, where each other occupant is sent a respective message that informs that said each other occupant about the contact with the traced occupant and any measures that should be taken in response to such contact.

Example 71 includes the system of any of Examples 66-70, wherein at least one of the alerts include tracked information, or information derived from tracked information.

Example 72 includes the system of Example 71, wherein said tracked information, or said information derived from tracked information, comprises at least one of: locations where contact occurred, duration of contact, and images that were captured.

What is claimed is:

1. A method of determining a location of a mobile device associated with an occupant within an indoor area, the method comprising:
receiving one or more images captured using at least one camera of the mobile device;
determining the location of the mobile device within the indoor area using the one or more images and a digital three-dimensional model of the indoor area; and
communicating information about the location of the mobile device to an emergency responder.

2. The method of claim 1, further comprising communicating the one or more images to server software, wherein the server software is configured to determine the location of the mobile device within the indoor area using the one or more images and the digital three-dimensional model of the indoor area.

3. The method of claim 1, wherein the method is performed in order to determine the respective locations of a plurality of occupant mobile devices within the indoor area using one or more images captured using the occupant mobile devices and the digital three-dimensional model of the indoor area, where information about the locations of the plurality of occupant mobile devices to the emergency responder.

4. The method of claim 1, wherein the method is repeated to track the location of the mobile device used by the occupant.

5. The method of claim 1, wherein determining the location of the mobile device within the indoor area using the one or more images and the digital three-dimensional model of the indoor area comprises:
recognizing one or more features in the one or more images; and
searching the digital three-dimensional model of the indoor area for the one or more features.

6. The method of claim 1, wherein communicating the information about the location of the mobile device to the emergency responder comprises:
determining a location of the emergency responder;
determining a route from the location of the emergency responder to the location of the mobile device using the digital three-dimensional model of the indoor area; and
communicating information about the route to the emergency responder.

7. The method of claim 6, wherein the information about the route comprises information for displaying a two-dimensional image of the route, the location of the mobile device, and the location of the emergency responder.

8. The method of claim 6, wherein the information about the route comprises information for displaying an augmented reality (AR) view that superimposes route information on an image of an area currently being captured by a mobile device used by the emergency responder.

9. The method of claim 6, wherein determining the location of the emergency responder comprises determining the location of a mobile device used by the emergency responder; and
wherein communicating the information about the route to the emergency responder comprises communicating the information about the route to the mobile device used by the emergency responder.

10. The method of claim 9, wherein determining the location of the mobile device used by the emergency responder comprises:
receiving one or more images captured using at least one camera of the mobile device used by the emergency responder; and
determining the location of the mobile device used by the emergency responder using the one or more images captured using the mobile device used by the emergency responder and the digital three-dimensional model of the indoor area.

11. The method of claim 1, wherein the mobile device comprises at least one of a smartphone, smart watch, smart glasses, a tablet, and a laptop computer.

12. The method of claim 1, wherein the indoor area comprises an interior of a building.

13. The method of claim 1, further comprising:
communicating information about the indoor area to the emergency responder.

14. The method of claim 13, wherein the information about the indoor area communicated to the emergency responder comprises information for displaying a three-hundred sixty (360) degree panoramic view of the indoor area on a mobile device used by the emergency responder.

15. A system for determining a location of a mobile device associated with an occupant within an indoor area, the system comprising:
an occupant mobile device used by the occupant, the occupant mobile device configured to execute occupant mobile software and comprising at least one camera; and
a responder mobile device used by an emergency responder, the responder mobile device configured to execute responder mobile software;
wherein the occupant mobile software is configured to capture one or more images using at least one camera of the occupant mobile device;
wherein the system is configured to determine the location of the responder mobile device within the indoor area using the one or more images and a digital three-dimensional model of the indoor area; and
wherein the system is configured to communicate information about the location of the mobile device to the responder mobile device.

16. The system of claim 15, further comprising a server computer configured to execute server software, wherein the one or more images are communicated to the server software, wherein the server software is configured to determine the location of the mobile device within the indoor area using the one or more images and the digital three-dimensional model of the indoor area.

17. The system of claim 16, wherein the server software is at least one of:
a part of a building information model system; and
configured to communicate with the building information model system.

18. The system of claim 15, wherein the system is configured to determine the respective locations of a plurality of occupant mobile devices within the indoor area using one or more images captured using the occupant mobile devices and the digital three-dimensional model of the indoor area, where information about the locations of the plurality of occupant mobile devices to the emergency responder.

19. The system of claim 15, wherein the system is configured to repeatedly determine the location of the mobile device used by the occupant in order to track the movement of the mobile device.

20. The system of claim 15, wherein the system is configured to determine the location of the responder mobile device within the indoor area using the one or more images and the digital three-dimensional model of the indoor area by:
recognizing one or more features in the one or more images; and
searching the digital three-dimensional model of the indoor area for the one or more features.

21. The system of claim 15, wherein the system is configured to communicate information about the location of the mobile device to the responder mobile device by:
determining a location of the responder mobile device;
determining a route from the location of the responder mobile device to the location of the occupant mobile device using the digital three-dimensional model of the indoor area; and
communicating information about the route to the responder mobile device.

22. The system of claim 21, wherein the information about the route comprises information for displaying a two-dimensional image of the route, the location of the occupant mobile device, and the location of the responder mobile device.

23. The system of claim 21, wherein the information about the route comprises information for displaying an augmented reality (AR) view that superimposes route information on an image of an area currently being captured by the responder mobile device.

24. The system of claim 21, wherein determining the location of the responder mobile device comprises:
receiving one or more images captured using at least one camera of the responder mobile device; and
determining the location of the responder mobile device using the one or more images captured using the responder mobile device and the digital three-dimensional model of the indoor area.

25. The system of claim 15, wherein the occupant mobile device comprises at least one of a smartphone, smart watch, smart glasses, a tablet, and a laptop computer; and
wherein the responder mobile device comprises at least one of a smartphone, smart watch, smart glasses, a tablet, and a laptop computer.

26. The system of claim 15, wherein the indoor area comprises an interior of a building.

27. The system of claim 15, wherein the system is configured to communicate information about the indoor area to the responder mobile device.

28. The system of claim 27, wherein the information about the indoor area communicated to the responder mobile device comprises information for displaying a three-hundred sixty (360) degree panoramic view of the indoor area on the responder mobile device.

29. A method of tracking locations of mobile devices associated with occupants within an indoor area, the method comprising:
receiving one or more images captured using at least one camera of the respective mobile device associated with each occupant within the indoor area;
determining the location of each mobile device within the indoor area using the respective one or more images and a digital three-dimensional model of the indoor area;
storing each determined location of each occupant mobile device of each occupant of the indoor area along with an associated time stamp; and
using at least some of the stored locations and time stamps in performing contact tracing.

30. The method of claim 29, wherein contact tracing is performed in response to an occupant testing positive for an infectious distance.

31. The method of claim 29, further comprising storing captured images and other information used in determining each determined location of each occupant mobile device of each occupant of the indoor area along with an associated time stamp.

32. The method of claim 31, wherein the locations, time stamps, captured images, and other information are stored by at least one server computer.

33. The method of claim 29, wherein storing each determined location of each occupant mobile device of each occupant of the indoor area along with an associated time stamp comprises: storing, along with each determined location of each occupant mobile device of each occupant of the indoor area along, at least one of an identifier for that occupant mobile device or an identifier associated with the occupant.

34. The method of claim 29, further comprising using the respective current location of the respective occupant mobile device of each occupant of the indoor area to check if that occupant is complying with one or more social distancing policies applicable to the indoor area.

35. The method of claim 34, wherein using the respective current location of the respective occupant mobile device of each occupant of the indoor area to check if that occupant is complying with one or more social distancing policies applicable to the indoor area is done in real-time.

36. The method of claim 35, further comprising at least one of:
sending an alert to the respective occupant mobile device of an occupant that is not complying with one or more of the social distancing policies applicable to the indoor area; and
sending an alert to a mobile device of another person in response to an occupant not complying with one or more of the social distancing policies applicable to the indoor area.

37. The method of claim 36, wherein said other person to which at least one alert is sent comprises a building security person

38. The method of claim 36, wherein at least one alert includes information identifying a respective occupant not complying with one or more social distancing policies and what said occupant should do to come into compliance with the one or more social distancing policies.

39. The method of claim 36, further comprising storing information about any non-compliance with the social distancing policies established for the indoor area and any alerts sent in response thereto along with associated time stamps.

40. The method of claim 29, further comprising communicating the one or more images to server software, wherein the server software is configured to determine the location of each mobile device within the indoor area using the one or more images and the digital three-dimensional model of the indoor area.

41. The method of claim 29, wherein determining the location of each mobile device within the indoor area using the respective one or more images and the digital three-dimensional model of the indoor area comprises:
recognizing one or more features in the one or more images; and
searching the digital three-dimensional model of the indoor area for the one or more features.

42. The method of claim 29, wherein each mobile device comprises at least one of a smartphone, smart watch, smart glasses, a tablet, and a laptop computer.

43. The method of claim 29, wherein the indoor area comprises an interior of a building.

44. The method of claim 29, wherein using at least some of the stored locations and time stamps in performing contact tracing comprises:
retrieving tracking information stored for a traced occupant during a period of interest;
identifying, using the traced occupant's retrieved tracking information, all other occupants of the indoor area who came into contact with the infected person while the traced occupant was in the indoor area during the period of interest; and
sending one or more alerts providing information about one or more of the other occupants who came into contact with the traced occupant while the traced occupant was in the indoor area during the period of interest.

45. The method of claim 44, wherein the determination of who came into contact with the traced occupant while the traced occupant was in the indoor area is a function of where the traced occupant was located in the indoor area during the period of interest.

46. The method of claim 44, wherein sending said one or more alerts comprises sending a message that identifies all other occupants who came into contact with the traced occupant while the traced occupant was in the indoor area during the period of interest, wherein the message is sent to a third party who will contact the other occupants and inform the other occupants about the contact with the traced occupant and any measures that should be taken in response to said contact.

47. The method of claim 46, wherein the third party comprises a team of contact tracers.

48. The method of claim 44, wherein sending said one or more alerts comprises sending a set of messages that are sent to the other occupants who came into contact with the traced occupant while the traced occupant was in the indoor area during the period of interest, where each other occupant is sent a respective message that informs that said each other occupant about the contact with the traced occupant and any measures that should be taken in response to such contact.

49. The method of claim 44, wherein at least one of the alerts include tracked information, or information derived from tracked information.

50. The method of claim 49, wherein said tracked information, or said information derived from tracked information, comprises at least one of: locations where contact occurred, duration of contact, and images that were captured.

51. A system for determining a location of mobile devices associated with occupants within an indoor area, the system comprising:
occupant mobile devices used by the occupants, the occupant mobile devices configured to execute occupant mobile software and each comprising at least one camera; and
wherein the occupant mobile software executed by each occupant mobile device is configured to capture one or more images using at least one camera of that occupant mobile device;
wherein the system is configured to:
determine the location of each mobile device within the indoor area using the respective one or more images and a digital three-dimensional model of the indoor area;
store each determined location of each occupant mobile device of each occupant of the indoor area along with an associated time stamp; and
use at least some of the stored locations and time stamps in performing contact tracing.

52. The system of claim 51, wherein the system is configured to perform contact tracing in response to an occupant testing positive for an infectious distance.

53. The system of claim 51, wherein the system is configured to store captured images and other information used in determining each determined location of each occupant mobile device of each occupant of the indoor area along with an associated time stamp.

54. The system of claim 53, wherein the system further comprises at least one server computer configured to store the locations, time stamps, captured images, and other information.

55. The system of claim 51, wherein the system is further configured to store, along with each determined location of each occupant mobile device of each occupant of the indoor area along, at least one of an identifier for that occupant mobile device or an identifier associated with the occupant.

56. The system of claim 51, wherein the system is configured to use the respective current location of the respective occupant mobile device of each occupant of the indoor area to check if that occupant is complying with one or more social distancing policies applicable to the indoor area.

57. The system of claim 56, wherein the system is configured to use the respective current location of the respective occupant mobile device of each occupant of the indoor area to check if that occupant is complying with one or more social distancing policies applicable to the indoor area in real-time.

58. The system of claim 57, wherein the system is configured to do at least one of:
send an alert to the respective occupant mobile device of an occupant that is not complying with one or more of the social distancing policies applicable to the indoor area; and
send an alert to a mobile device of another person in response to an occupant not complying with one or more of the social distancing policies applicable to the indoor area.

59. The system of claim 58, wherein said other person to which at least one alert is sent comprises a building security person

60. The system of claim 58, wherein the system is configured so that at least one alert includes information identifying a respective occupant not complying with one or more social distancing policies and what said occupant should do to come into compliance with the one or more social distancing policies.

61. The system of claim 58, wherein the system is configured to store information about any non-compliance with the social distancing policies established for the indoor area and any alerts sent in response thereto along with associated time stamps.

62. The system of claim 51, wherein the system is configured to communicate the one or more images to server software, wherein the server software is configured to determine the location of each mobile device within the indoor area using the one or more images and the digital three-dimensional model of the indoor area.

63. The system of claim 51, wherein the system is configured to determine the location of each mobile device within the indoor area using the respective one or more images and the digital three-dimensional model of the indoor area by doing the following:
recognizing one or more features in the one or more images; and
searching the digital three-dimensional model of the indoor area for the one or more features.

64. The system of claim 51, wherein each mobile device comprises at least one of a smartphone, smart watch, smart glasses, a tablet, and a laptop computer.

65. The system of claim 51, wherein the indoor area comprises an interior of a building.

66. The system of claim 51, wherein the system is configured to use at least some of the stored locations and time stamps in performing contact tracing by doing the following:
retrieve tracking information stored for a traced occupant during a period of interest;
identify, using the traced occupant's retrieved tracking information, all other occupants of the indoor area who came into contact with the infected person while the traced occupant was in the indoor area during the period of interest; and
send one or more alerts providing information about one or more of the other occupants who came into contact with the traced occupant while the traced occupant was in the indoor area during the period of interest.

67. The system of claim 66, wherein the determination of who came into contact with the traced occupant while the traced occupant was in the indoor area is a function of where the traced occupant was located in the indoor area during the period of interest.

68. The system of claim 66, wherein the system is configured to send said one or more alerts by sending a message that identifies all other occupants who came into contact with the traced occupant while the traced occupant was in the indoor area during the period of interest, wherein the message is sent to a third party who will contact the other occupants and inform the other occupants about the contact with the traced occupant and any measures that should be taken in response to said contact.

69. The system of claim 68, wherein the third party comprises a team of contact tracers.

70. The system of claim 66, wherein the system is configured to send said one or more alerts by sending a set of messages that are sent to the other occupants who came into contact with the traced occupant while the traced occupant was in the indoor area during the period of interest, where each other occupant is sent a respective message that informs that said each other occupant about the contact with the traced occupant and any measures that should be taken in response to such contact.

71. The system of claim 66, wherein at least one of the alerts include tracked information, or information derived from tracked information.

72. The system of claim 71, wherein said tracked information, or said information derived from tracked information, comprises at least one of: locations where contact occurred, duration of contact, and images that were captured.
